(19) United States
(12) Patent Application Publication
(10) Pub. No.: US 2024/0427020 A1
(43) Pub. Date: Dec. 26, 2024

(54) DISTANCE MEASURING DEVICE, METHOD FOR CONTROLLING THE SAME, AND DISTANCE MEASURING SYSTEM

(71) Applicant: SONY GROUP CORPORATION, TOKYO (JP)

(72) Inventors: TAKAYUKI SASAKI, TOKYO (JP); KENICHIRO NAKAMURA, TOKYO (JP); YUSUKE MORIUCHI, TOKYO (JP); MOTONOBU FUJIOKA, TOKYO (JP)

(21) Appl. No.: 18/262,736

(22) PCT Filed: Dec. 27, 2021
(86) PCT No.: PCT/JP2021/048507

§ 371 Date: Jul. 25, 2023

(30) Foreign Application Priority Data
Feb. 2, 2021 (JP) 2021-014814

(51) Int. Cl. G01S 17/894; G01S 7/4863; G01S 7/4865; G01S 17/86; G06T 7/13

(52) U.S. Cl. CPC G01S 17/894; G01S 7/4863; G01S 7/4865; G01S 17/86; G06T 7/13

(57) ABSTRACT

The present technology relates to a distance measuring device, a method for controlling the same, and a distance measuring system that allow for generation of a high-resolution depth image with high accuracy from sparse depth information. The distance measuring device includes: a light receiving unit that has a plurality of pixels that receive reflected light obtained from irradiation light reflected by an object; a high-resolution processing unit that generates a high-resolution depth image from a sparse depth image acquired by the light receiving unit; and a position determination unit that determines an active pixel in which a light receiving operation is performed in the light receiving unit on the basis of edge information of the high-resolution depth image. The present technology can be applied to, for example, a distance measuring system or the like that detects a distance to a subject in a depth direction.

### TECHNICAL FIELD

The present technology relates to a distance measuring device, a method for controlling the same, and a distance measuring system, and more particularly, to a distance measuring device, a method for controlling the same, and a distance measuring system capable of generating a high-resolution depth image with high accuracy from sparse depth information.

### BACKGROUND ART

In recent years, distance measuring devices (hereinafter referred to as depth cameras) that use a time-of-flight (ToF) technique to measure a distance have attracted attention. Some depth cameras use a single photon avalanche diode (SPAD) for a light receiving pixel. In a depth camera using a SPAD, avalanche amplification occurs when one photon enters a PN junction region with a high electric field in a state where a voltage larger than a breakdown voltage is applied. By detecting a timing at which a current instantaneously flowed due to the avalanche amplification, it is possible to detect a timing at which light arrived with high accuracy, and measure the distance (see, for example, Patent Document 1).

In the depth camera using the SPAD, in the present circumstances, a pixel array in which light receiving pixels are two-dimensionally arranged has a low resolution, and depth information that can be acquired is sparse information in many cases. For such a case, for example, a technology for increasing the resolution of a low-resolution depth image by using a color image captured by an RGB camera has been proposed (see, for example, Non Patent Document 1).

### CITATION LIST

### Patent Document

Patent Document 1: Japanese Patent Application Laid-Open No. 2020-134171

### Non Patent Document

Non Patent Document 1: Fangchang Ma, Guilherme Venturelli Cavalheiro, Sertac Karaman, “Self-Supervised Sparse-to-Dense: Self-Supervised Depth Completion from LiDAR and Monocular Camera”, Massachusetts Institute of Technology, 3 Jul. 2018, [Retrieved Jan. 7, 2021], Internet <URL: https://arxiv.org/pdf/1807.00275v2.pdf>

### SUMMARY OF THE INVENTION

### Problems to be Solved by the Invention

However, in a case of increasing the resolution of sparse depth information, there has been cases where the accuracy deteriorates depending on pixel positions of the sparse depth information.

The present technology has been made in view of such a situation, and enables generation of a high-resolution depth image with high accuracy from sparse depth information.

### Solutions to Problems

A first aspect of the present technology provides a distance measuring device including: a light receiving unit that has a plurality of pixels that receive reflected light obtained from irradiation light reflected by an object; a high-resolution processing unit that generates a high-resolution depth image from a sparse depth image acquired by the light receiving unit; and a position determination unit that determines an active pixel in which a light receiving operation is performed in the light receiving unit on the basis of edge information of the high-resolution depth image.

A second aspect of the present technology provides a method for controlling a distance measuring device, the method including: by the distance measuring device including a light receiving unit that has a plurality of pixels that receive reflected light obtained from irradiation light reflected by an object, generating a high-resolution depth image from a sparse depth image acquired by the light receiving unit; and determining an active pixel in which a light receiving operation is performed in the light receiving unit on the basis of edge information of the high-resolution depth image.

A third aspect of the present technology provides a distance measuring system including: an illumination device that performs irradiation of irradiation light; and a distance measuring device that receives reflected light obtained from the irradiation light reflected by an object, in which the distance measuring device includes: a light receiving unit that has a plurality of pixels that receive the reflected light; a high-resolution processing unit that generates a high-resolution depth image from a sparse depth image acquired by the light receiving unit; and a position determination unit that determines an active pixel in which a light receiving operation is performed in the light receiving unit on the basis of edge information of the high-resolution depth image.

In the first to third aspects of the present technology, a high-resolution depth image is generated from a sparse depth image acquired by the light receiving unit that has a plurality of pixels that receive reflected light obtained from irradiation light reflected by an object, and an active pixel in which a light receiving operation is performed in the light receiving unit is determined on the basis of edge information of the high-resolution depth image.

The distance measuring device and the distance measuring system may be independent devices, or may be modules incorporated in other devices.

### BRIEF DESCRIPTION OF DRAWINGS

FIG. 1 is a block diagram illustrating a configuration example of one embodiment of a distance measuring system of the present disclosure.

FIG. 2 is a diagram illustrating a configuration of an illumination device.

FIG. 3 is a diagram illustrating an example of an irradiation pattern of irradiation by the illumination device.

FIG. 4 is a block diagram illustrating a more detailed configuration example of a distance measuring device in FIG. 1.

FIG. 5 is a diagram illustrating an arrangement example of active pixels.

FIG. 6 is a diagram illustrating an example of a color image and a high-resolution depth image.

FIG. 7 is a diagram illustrating processing of an edge information detection unit and an adaptive sampling unit.

FIG. 8 is a flowchart illustrating distance measuring processing of the distance measuring system in FIG. 1.

FIG. 9 is a detailed flowchart of high-resolution depth image generation processing executed as step S4 in FIG. 8.

FIG. 10 is a diagram illustrating processing of determining whether a sampling position is on an edge.

FIG. 11 is a diagram illustrating a method of determining a movement direction and a movement amount of a sampling position.

FIG. 12 is a diagram illustrating the method of determining a movement direction and a movement amount of a sampling position.

FIG. 13 is a diagram illustrating the method of determining a movement direction and a movement amount of a sampling position.

FIG. 14 is a block diagram illustrating a detailed configuration example of the distance measuring device in a case where a distance measuring mode is a luminance observation mode.

FIG. 15 is a flowchart illustrating high-resolution depth image processing in which a high-resolution depth image is generated by using a high-resolution depth image and a luminance image.

### MODE FOR CARRYING OUT THE INVENTION

A mode for carrying out the present technology (hereinafter referred to as an embodiment) will be described below with reference to the accompanying drawings. Note that, in the present specification and drawings, components having substantially the same functional configurations are denoted by the same reference numerals, and the description thereof will thus not be repeated. The description will be given in the order below.

1. Configuration example of distance measuring system

2. Detailed configuration example of distance measuring device

3. Flowchart of distance measuring processing

4. Another example of high-resolution depth generation processing

5. Modified examples

### 1. Configuration Example of Distance Measuring System

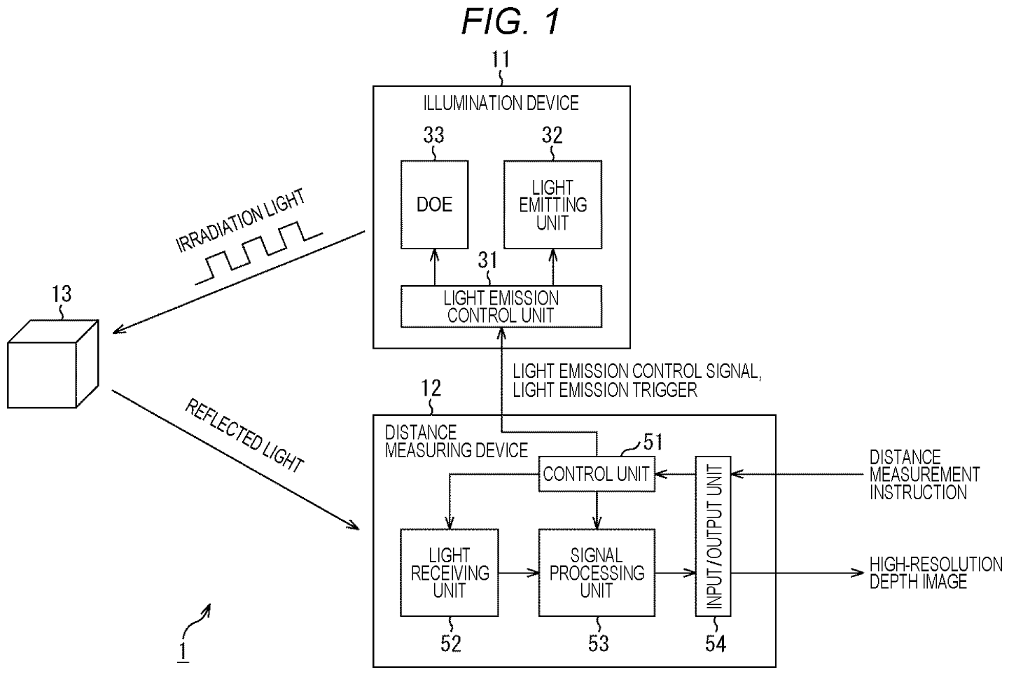

FIG. 1 is a block diagram illustrating a configuration example of one embodiment of a distance measuring system of the present disclosure.

A distance measuring system 1 in FIG. 1 is a system that measures and outputs a distance to an object by using, for example, a time-of-flight (ToF) technique. Here, the distance measuring system 1 performs distance measurement using a direct ToF method, which is one of ToF techniques. The direct ToF method is a method of computing the distance to an object by directly measuring the flight time from the timing at which irradiation light is emitted to the timing at which the reflected light is received.

The distance measuring system 1 includes an illumination device 11 and a distance measuring device 12, and measures a distance to a predetermined object 13 as a subject. More specifically, when a distance measurement instruction is supplied from an upper host device, the distance measuring system 1 repeats emission of irradiation light and reception of the reflected light a predetermined number of times (e.g., several to several hundred times). The distance measuring system 1 generates a histogram of the flight time of irradiation light on the basis of the emission of irradiation light and the reception of the reflected light repeatedly executed the predetermined number of times, and computes the distance to the object 13 from the flight time corresponding to a peak of the histogram.

The illumination device 11 irradiates the predetermined object 13 with irradiation light on the basis of a light emission control signal and a light emission trigger supplied from the distance measuring device 12. As the irradiation light, for example, infrared light (IR light) having a wavelength in a range of about 850 nm to 940 nm is used. The illumination device 11 includes a light emission control unit 31, a light emitting unit 32, and a diffractive optical element (DOE) 33.

When a distance measurement instruction is supplied, the distance measuring device 12 determines light emission conditions, and outputs, on the basis of the determined light emission conditions, a light emission control signal and a light emission trigger to the illumination device 11 for irradiation with irradiation light. The light emission conditions determined here include, for example, various types of information such as an irradiation method, an irradiation area, and an irradiation pattern. The distance measuring device 12 receives reflected light, which is the irradiation light reflected by the object 13, calculates the distance to the object 13, and outputs a result of the calculation as a depth image to the upper host device. The distance measuring device 12 includes a control unit 51, a light receiving unit 52, a signal processing unit 53, and an input/output unit 54.

The distance measuring system 1 is used together with an RGB camera (not illustrated) that captures an image of a subject including the object 13. In other words, the distance measuring system 1 sets, as a distance measurement range, the same range as an imaging range of the RGB camera, which is an external camera, and generates information regarding the distance to the subject captured by the RGB camera. However, since the resolution of the light receiving unit 52 of the distance measuring device 12 is lower than the resolution of a color image generated by the RGB camera, the distance measuring device 12 generates and outputs, by the signal processing unit 53, a high-resolution depth image, which is a depth image in which the resolution has been increased to the same resolution as the resolution of the color image.

The light emission control unit 31 of the illumination device 11 includes, for example, a microprocessor, an LSI, and a laser driver, and controls the light emitting unit 32 and the diffractive optical element 33 on the basis of a light emission control signal supplied from the control unit 51 of the distance measuring device 12. Furthermore, the light emission control unit 31 causes irradiation light to be emitted in accordance with a light emission trigger supplied from the control unit 51 of the distance measuring device 12. The light emission trigger is, for example, a pulse waveform constituted by two values: “High (1)” and “Low (0)”, and “High” represents a timing at which irradiation light is emitted.

The light emitting unit 32 includes, for example, a VCSEL array in which a plurality of vertical cavity surface emitting lasers (VCSELs) as light sources are arrayed in a planar manner, and each VCSEL turns on or off light emission in accordance with a light emission trigger. The unit of light emission of the VCSELs (size of the light source) and the position of a VCSEL to be caused to emit light (light emitting position) can be changed by the control of the light emission control unit 31.

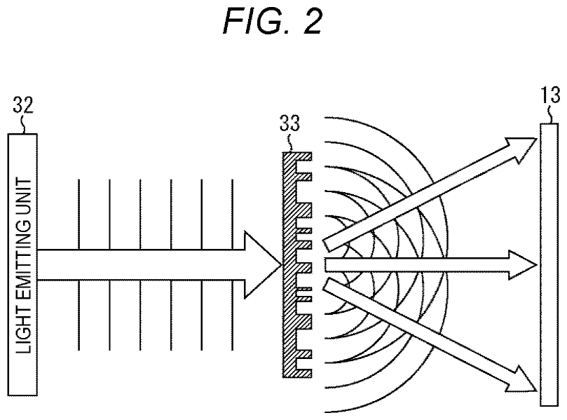

As illustrated in FIG. 2, the diffractive optical element 33 enlarges the irradiation area by replicating, in a direction perpendicular to an optical axis direction, a light emission pattern of a predetermined region that has been emitted from the light emitting unit 32 and has passed through a projection lens (not illustrated). By using a convertible lens, a liquid crystal element, or the like instead of the diffractive optical element 33, or together with the diffractive optical element 33, it is possible to switch between spot irradiation and planar irradiation or switch the light emission pattern (irradiation region) to a specific pattern. Alternatively, for example, a photonic crystal surface emitting lase may be used to change the light emission pattern with which the object 13 is irradiated to a specific pattern. A technology for controlling a light emission pattern by using a photonic crystal surface emitting laser is disclosed in, for example, ““Feature: Next-Generation Laser Light Source! Advancement of Photonic Crystal Lasers/Progress of Broad-Area Coherent Photonic Crystal Lasers” De Zoysa Menaka, Masahiro Yoshida, Yoshinori Tanaka, Susumu Noda, OPTRONICS (2017) No. 5”.

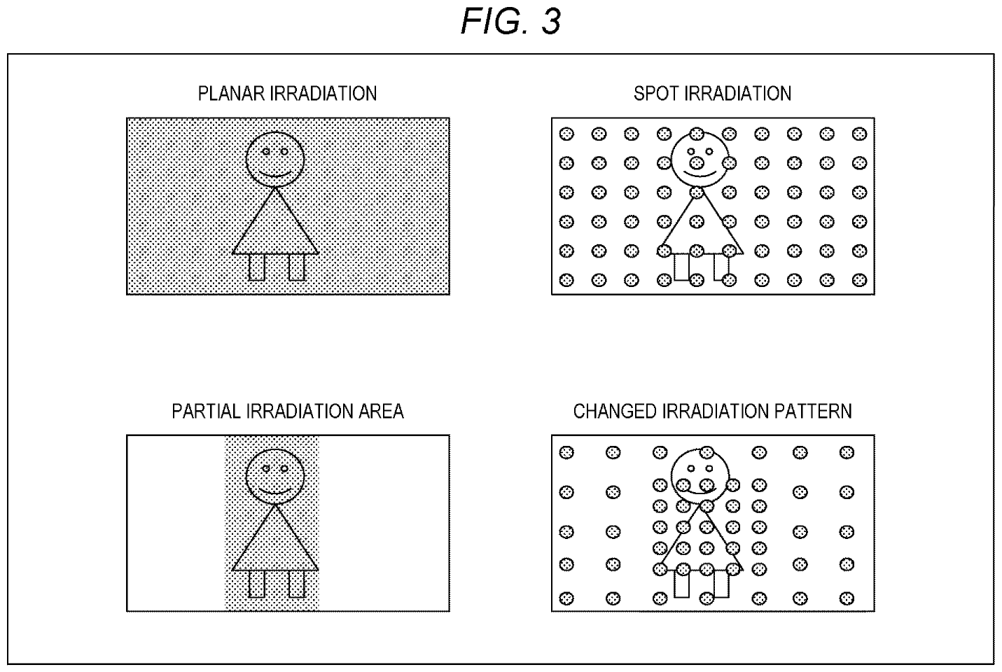

FIG. 3 illustrates an example of an irradiation pattern with which the illumination device 11 irradiates the object 13 on the basis of light emission conditions supplied from the control unit 51.

When performing irradiation, the illumination device 11 can select, as the irradiation method, either planar irradiation in which a predetermined irradiation area is irradiated with uniform light emission intensity within a predetermined luminance range, or spot irradiation in which the irradiation area is a plurality of spots (circles) arranged at a predetermined interval. Planar irradiation allows for measurement (light reception) with higher resolution, but the irradiation light is diffused, and this results in lower light emission intensity and a shorter measurement range. On the other hand, spot irradiation provides higher light emission intensity, and a depth value that is robust against noise (highly reliable) can be obtained, but the resolution is lower.

Furthermore, the illumination device 11 can partially irradiate the irradiation area or change the light emission intensity. By emitting light in a necessary region and light emission intensity, it is possible to reduce power and avoid saturation of the light receiving unit at a short distance. Reducing the light emission intensity also contributes to compliance in terms of eye safe.

Moreover, instead of uniformly irradiating the inside of the irradiation area, the illumination device 11 can switch the irradiation pattern to a specific pattern and perform irradiation, such as irradiating a specific area (e.g., a center area) with high density and irradiating other areas (e.g., an outer peripheral area) with low density.

The description returns to FIG. 1.

The control unit 51 of the distance measuring device 12 includes, for example, a field programmable gate array (FPGA), a digital signal processor (DSP), and a microprocessor. When acquiring a distance measurement instruction from the upper host device via the input/output unit 54, the control unit 51 determines light emission conditions, and supplies, to the light emission control unit 31 of the illumination device 11, a light emission control signal and a light emission trigger corresponding to the determined light emission conditions. Furthermore, the control unit 51 supplies the generated light emission trigger also to the signal processing unit 53, and determines which of pixels in the light receiving unit 52 are to be active pixels in accordance with the determined light emission conditions. The active pixel is a pixel that detects incidence of a photon. A pixel that does not detect incidence of a photon is referred to as an inactive pixel.

The light receiving unit 52 has a pixel array in which pixels for detecting incidence of photons are two-dimensionally arranged in a matrix. Each pixel of the light receiving unit 52 includes a single photon avalanche diode (SPAD) as a photoelectric conversion element. The SPAD instantaneously detects one photon by multiplying carriers generated by photoelectric conversion in a PN junction region (multiplication region) with a high electric field. When detecting incidence of a photon, each active pixel of the light receiving unit 52 outputs, to the signal processing unit 53, a detection signal indicating that a photon has been detected.

On the basis of emission of irradiation light and reception of the reflected light repeatedly executed a predetermined number of times (e.g., several to several hundred times), the signal processing unit 53 generates a histogram of the time (count value) from when irradiation light is emitted to when the reflected light is received. Then, the signal processing unit 53 detects the peak of the generated histogram, thereby determining the time until irradiation light from the illumination device 11 is reflected by the object 13 and returns, and obtaining the distance to the object 13 on the basis of the determined time and the speed of light. The signal processing unit 53 includes, for example, a field programmable gate array (FPGA), a digital signal processor (DSP), and a logic circuit.

As described above, the resolution of the pixel array that the light receiving unit 52 has is lower than the resolution of a color image generated by the RGB camera. Thus, the signal processing unit 53 executes high-resolution processing in which a high-resolution depth image having the same resolution as the resolution of the color image is generated from a low-resolution depth image generated on the basis of a result of light reception by the light receiving unit 52. The generated high-resolution depth image is output to a device in a subsequent stage via the input/output unit 54.

The input/output unit 54 supplies, to the control unit 51, a distance measurement instruction supplied from the upper host device. Furthermore, the input/output unit 54 outputs, to the upper host device, a high-resolution depth image supplied from the signal processing unit 53.

The distance measuring device 12 has two modes: a distance measuring mode and a luminance observation mode, as operation modes. The distance measuring mode is a mode in which some pixels among a plurality of pixels that the light receiving unit 52 has are set as active pixels and the remaining pixels are set as inactive pixels, and a high-resolution depth image is generated from a low-resolution depth image generated on the basis of the active pixels and then output. The luminance observation mode is a mode in which all pixels of the light receiving unit 52 are set as active pixels, and a luminance image is generated in which the number of photons input in a certain period is counted as a luminance value (pixel value).

### 2. Detailed Configuration Example of Distance Measuring Device

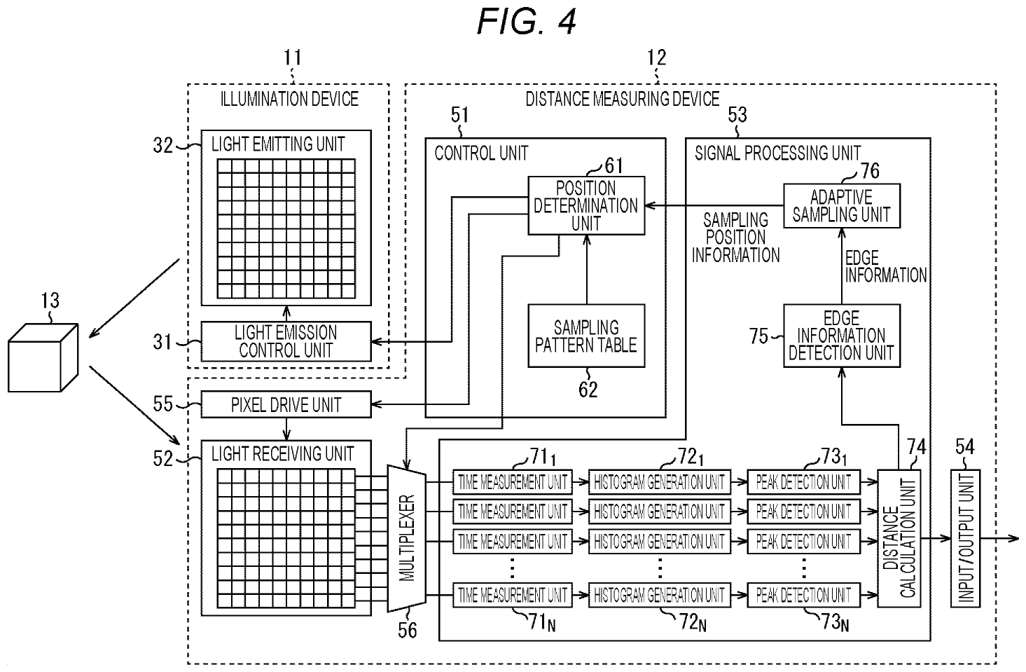

FIG. 4 is a block diagram illustrating a more detailed configuration example of the distance measuring device 12 in a case where the operation mode is the distance measuring mode. Note that in FIG. 4, the diffractive optical element 33 is not illustrated in the illumination device 11.

The distance measuring device 12 has the control unit 51, the light receiving unit 52, the signal processing unit 53, the input/output unit 54, a pixel drive unit 55, and a multiplexer 56.

The control unit 51 has a position determination unit 61 and a sampling pattern table 62.

The signal processing unit 53 has time measurement units 71₁ to 71_{N}, histogram generation units 72₁ to 72_{N}, peak detection units 73₁ to 73_{N}, a distance calculation unit 74, an edge information detection unit 75, and an adaptive sampling unit 76. The signal processing unit 53 has a configuration in which N (N>1) time measurement units 71, N histogram generation units 72, and N peak detection units 73 are provided so that N histograms can be generated. In a case where N is equal to the total number of pixels of the light receiving unit 52, a histogram can be generated in units of a pixel.

The position determination unit 61 determines a light emitting position in the VCSEL array as the light emitting unit 32 of the illumination device 11 and a light reception position in the pixel array of the light receiving unit 52. That is, the position determination unit 61 determines light emission conditions such as planar irradiation, spot irradiation, light emission area, and irradiation pattern, and supplies, to the light emission control unit 31 of the illumination device 11, a light emission control signal indicating which of the VCSELs in the VCSEL array are to be caused to emit light on the basis of the determined light emission conditions. Furthermore, in accordance with the determined light emission conditions, the position determination unit 61 determines which of the pixels in the pixel array are to be active pixels on the basis of the sampling pattern table 62 stored in an internal memory. The sampling pattern table 62 stores position information indicating the pixel position of each pixel in the pixel array of the light receiving unit 52.

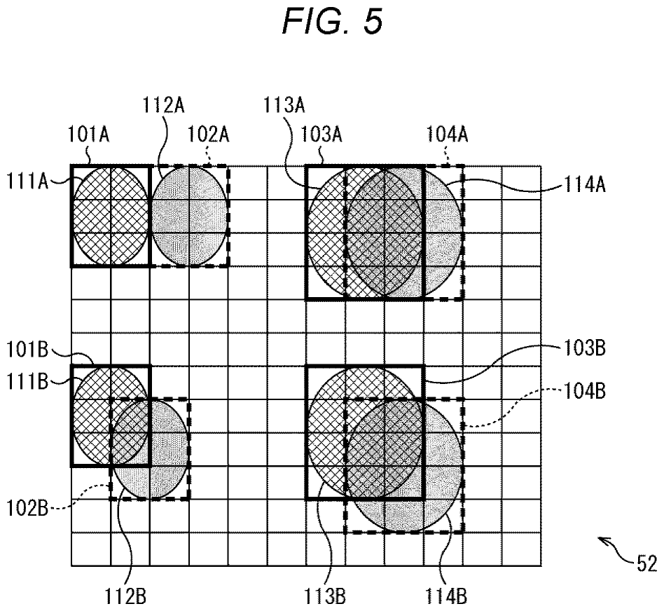

FIG. 5 illustrates an example of determining active pixels on the basis of light emission conditions.

In accordance with the size and position of the light source (VCSEL) to be caused to emit light in the light emitting unit 32, the position determination unit 61 determines the pixel positions of active pixels and the unit by which a histogram is generated. For example, under a certain light emission condition, it is assumed that spot light irradiation from the illumination device 11 is incident on the pixel array of the light receiving unit 52, such as a region 111A and a region 111B. In this case, the position determination unit 61 sets each pixel in a 2×3 pixel region 101A and a 2×3 pixel region 101B corresponding to the region 111A and the region 111B as an active pixel, and determines each of the pixel region 101A and the pixel region 101B as the unit by which one histogram is generated. Furthermore, for example, in a case where it is assumed that spot light is incident as indicated by a region 112A and a region 112B, the position determination unit 61 sets each pixel in a 2×3 pixel region 102A and a 2×3 pixel region 102B as an active pixel, and determines each of the pixel region 102A and the pixel region 102B as the unit by which one histogram is generated.

Similarly, in a case where it is assumed that spot light is incident as indicated by a region 113A and a region 113B, the position determination unit 61 sets each pixel in a 3×4 pixel region 103A and a 3×4 pixel region 103B as an active pixel, and determines each of the pixel region 103A and the pixel region 103B as the unit by which one histogram is generated. Furthermore, in a case where it is assumed that spot light is incident as indicated by a region 114A and a region 114B, the position determination unit 61 sets each pixel in a 3×4 pixel region 104A and a 3×4 pixel region 104B as an active pixel, and determines each of the pixel region 104A and the pixel region 104B as the unit by which one histogram is generated. A plurality of active pixels set as the unit by which one histogram is generated will be hereinafter referred to as a macropixel.

Returning to FIG. 4, the position determination unit 61 supplies the pixel drive unit 55 with active pixel control information for specifying the determined active pixels. Furthermore, the position determination unit 61 supplies the multiplexer 56 with histogram generation control information for specifying the unit by which a histogram is generated.

Moreover, the position determination unit 61 is supplied with sampling position information from the signal processing unit 53 in a case where a high-resolution depth image has been generated in the signal processing unit 53. The sampling position information supplied from the signal processing unit 53 is information indicating an optimum sampling position determined by the signal processing unit 53 on the basis of the high-resolution depth image.

The position determination unit 61 determines whether or not it is necessary to change an active pixel on the basis of the sampling position information supplied from the signal processing unit 53 and the sampling pattern table 62. In a case where it has been determined that an active pixel needs to be changed, the position determination unit 61 changes the active pixel to an inactive pixel, and determines another inactive pixel as a new active pixel. Then, active pixel control information based on the active pixels after the change is supplied to the pixel drive unit 55, and histogram generation control information is supplied to the multiplexer 56.

The pixel drive unit 55 controls the active pixels and the inactive pixels on the basis of the active pixel control information supplied from the position determination unit 61. In other words, the pixel drive unit 55 controls on/off of a light receiving operation of each pixel of the light receiving unit 52. When incidence of a photon is detected in each pixel set as an active pixel in the light receiving unit 52, a detection signal indicating detection of a photon is output as a pixel signal to the signal processing unit 53 via the multiplexer 56.

The multiplexer 56 distributes the pixel signal supplied from the active pixel of the light receiving unit 52 to any one of the time measurement units 71₁ to 71_{N} on the basis of the histogram generation control information supplied from the position determination unit 61. In other words, the multiplexer 56 performs control such that each pixel signal from the active pixels of the light receiving unit 52 is supplied to the same time measurement unit 71ᵢ (i=any one of 1 to N) in units of a macropixel.

Although not illustrated in FIG. 4, the time measurement unit 71ᵢ (i=any one of 1 to N) of the signal processing unit 53 is also supplied with a light emission trigger that is supplied from the control unit 51 to the light emission control unit 31 of the illumination device 11. On the basis of a light emission timing indicated by the light emission trigger and the pixel signal supplied from each active pixel of the macropixel, the time measurement unit 71ᵢ generates a count value corresponding to the time from when the light emitting unit 32 emits irradiation light to when the active pixel receives the reflected light. The generated count value is supplied to the corresponding histogram generation unit 72ᵢ. The time measurement unit 71ᵢ is also referred to as a time to digital converter (TDC).

The histogram generation unit 72ᵢ creates a histogram of count values on the basis of the count values supplied from the time measurement unit 71ᵢ. Data of the generated histogram is supplied to the corresponding peak detection unit 73ᵢ.

The peak detection unit 73ᵢ detects the peak of the histogram on the basis of the data of the histogram supplied from the histogram generation unit 72ᵢ. The peak detection unit 73ᵢ supplies the distance calculation unit 74 with a count value corresponding to the detected peak of the histogram.

The distance calculation unit 74 computes the flight time of the irradiation light on the basis of the count value corresponding to the peak of the histogram supplied from each of the peak detection units 73₁ to 73_{N} in units of a macropixel. The distance calculation unit 74 calculates the distance to the subject from the computed flight time, and generates a depth image in which the distance as a calculation result is stored as a pixel value. Since the resolution of the light receiving unit 52 is lower than the resolution of a color image generated by the RGB camera, the depth image generated here is a sparse depth image in which the resolution is lower than the resolution of the color image even in a case where N is the total number of pixels of the light receiving unit 52.

Thus, the distance calculation unit 74 further executes high-resolution processing in which the resolution of the generated sparse depth image is increased to the same resolution as the color image generated by the RGB camera. That is, the distance calculation unit 74 includes a high-resolution processing unit that generates a high-resolution depth image from a sparse depth image. The generated high-resolution depth image is output to the outside via the input/output unit 54 and supplied to the edge information detection unit 75. The high-resolution processing can be implemented by, for example, applying a known technology using a deep neural network (DNN).

The edge information detection unit 75 detects edge information indicating a boundary of an object on the basis of the high-resolution depth image supplied from the distance calculation unit 74, and supplies the detection result to the adaptive sampling unit 76. Examples of a technology for detecting edge information from a depth image include “Holistically-Nested Edge Detection”, Saining Xie, Zhuowen Tu (https://arxiv.org/pdf/1504.06375.pdf), which uses a DNN.

On the basis of the edge information supplied from the edge information detection unit 75, the adaptive sampling unit 76 determines whether or not a position that is currently set as a macropixel (the position is hereinafter also referred to as a sampling position) is on an edge of an object, for all sampling positions. It is possible to grasp information regarding the position set as a macropixel by acquiring active pixel control information generated by the position determination unit 61.

In a case where it has been determined that a predetermined sampling position is on an edge of an object, the adaptive sampling unit 76 calculates a movement direction and a movement amount for moving the sampling position from the edge of the object. As for the sampling position determined to be on an edge of an object, the adaptive sampling unit 76 changes the position information to position information of a new sampling position obtained by moving the sampling position in accordance with the calculated movement direction and movement amount, and then supplies sampling position information of all sampling positions to the position determination unit 61 of the control unit 51. Note that the adaptive sampling unit 76 may supply the position determination unit 61 with only sampling position information of the new sampling position that needs to be changed.

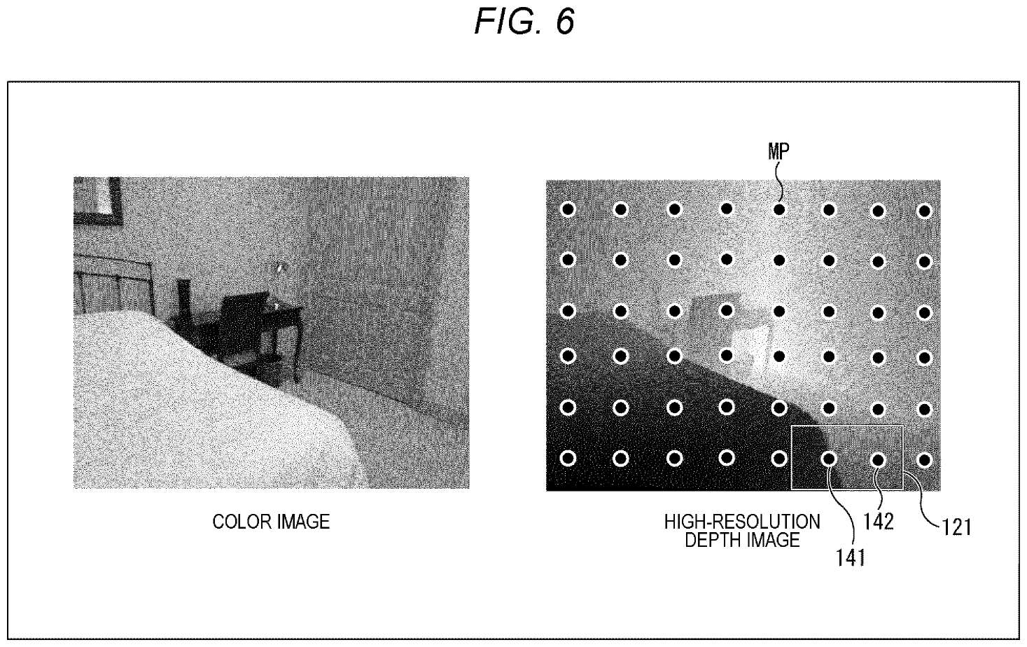

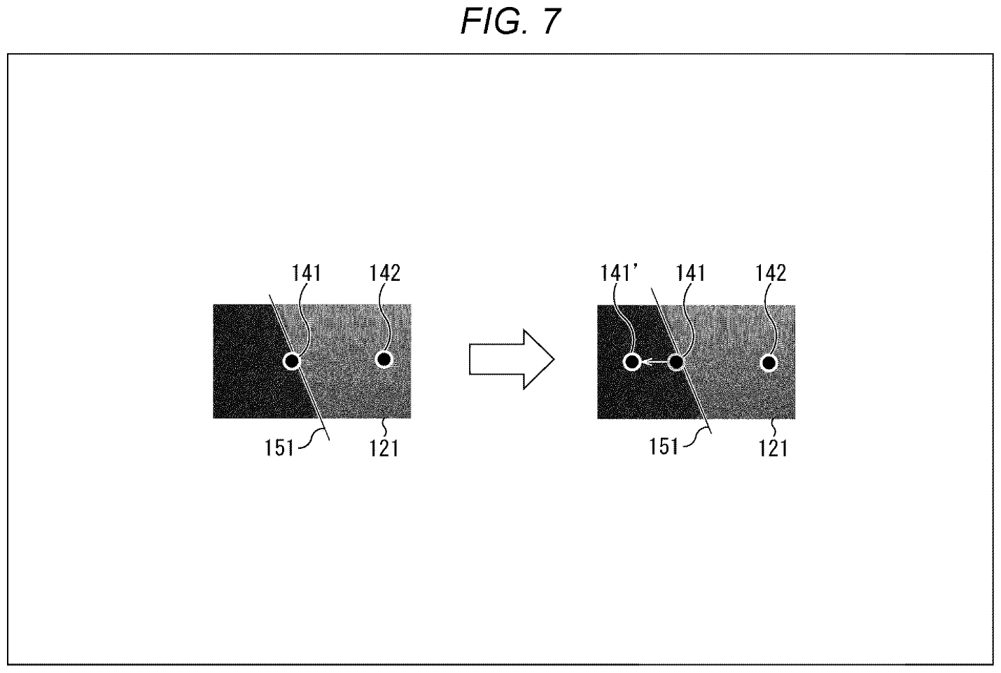

Processing of the edge information detection unit 75 and the adaptive sampling unit 76 will be described with reference to FIGS. 6 and 7.

FIG. 6 illustrates an example of a color image generated by an RGB camera and a high-resolution depth image in which the resolution has been increased to the same resolution as that of the color image.

A high-resolution depth image is an image in which information regarding the distance to an object is indicated by a gray value of a predetermined number of bits (e.g., 10 bits), and in the high-resolution depth image in FIG. 6, the indicated value is darker as the distance to the object is shorter. The edge information detection unit 75 detects a boundary of the gray value corresponding to the distance as edge information.

Each of points MP, which are white surrounding the peripheries of black dots and are shown so as to be superimposed on the high-resolution depth image at equal intervals, indicates a current sampling position in the light receiving unit 52, that is, the position of a macropixel.

In the high-resolution depth image in FIG. 6, attention is focused a region 121 in which a boundary of an object is relatively clearly shown. The region 121 includes a first sampling position 141 and a second sampling position 142 as current sampling positions.

FIG. 7 is an enlarged view of the region 121 in the high-resolution depth image in FIG. 6.

As illustrated in the region 121 on the left in FIG. 7, it is assumed that an edge 151 has been detected in the region 121 in the high-resolution depth image by edge information detection processing of the edge information detection unit 75. In this case, the adaptive sampling unit 76 determines that the first sampling position 141 is on the edge 151, and the second sampling position 142 is not on any edge.

Then, for the first sampling position 141 determined to be on an edge of an object, the adaptive sampling unit 76 calculates a new sampling position 141′ obtained by moving the first sampling position 141 so as not to be on the edge of the object, and supplies the position determination unit 61 of the control unit 51 with sampling position information including position information of the new sampling position 141′. The computation of the new sampling position 141′ will be described later.

### 3. Flowchart of Distance Measuring Processing

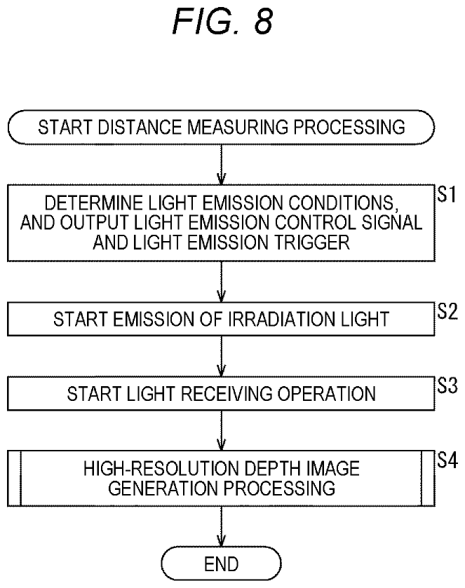

Next, distance measuring processing of the distance measuring system 1 will be described with reference to a flowchart in FIG. 8. This processing is started, for example, when a distance measurement instruction is supplied from the upper host device.

First, in step S1, the distance measuring device 12 determines light emission conditions, and outputs, to the illumination device 11, a light emission control signal and a light emission trigger for controlling a VCSEL to be caused to emit light and the timing on the basis of the determined light emission conditions. Furthermore, the position determination unit 61 of the distance measuring device 12 supplies the pixel drive unit 55 with active pixel control information for specifying an active pixel on the basis of the determined light emission conditions, and supplies the multiplexer 56 with histogram generation control information for specifying the unit by which a histogram is generated.

In step S2, the illumination device 11 starts emission of irradiation light. More specifically, the light emission control unit 31 controls the diffractive optical element 33 on the basis of the light emission control signal from the distance measuring device 12, and turns on or off a predetermined VCSEL of the light emitting unit 32 on the basis of the light emission trigger.

In step S3, the distance measuring device 12 starts a light receiving operation. More specifically, the pixel drive unit 55 drives a predetermined pixel as an active pixel on the basis of the active pixel control information from the position determination unit 61. When a photon is detected in the active pixel, a detection signal indicating the detection is output as a pixel signal to the signal processing unit 53 via the multiplexer 56.

In step S4, the distance measuring device 12 executes high-resolution depth image generation processing in which a high-resolution depth image is generated. The distance measuring device 12 outputs, to the upper host device, the high-resolution depth image obtained as a result of the high-resolution depth image generation processing, and ends the distance measuring processing.

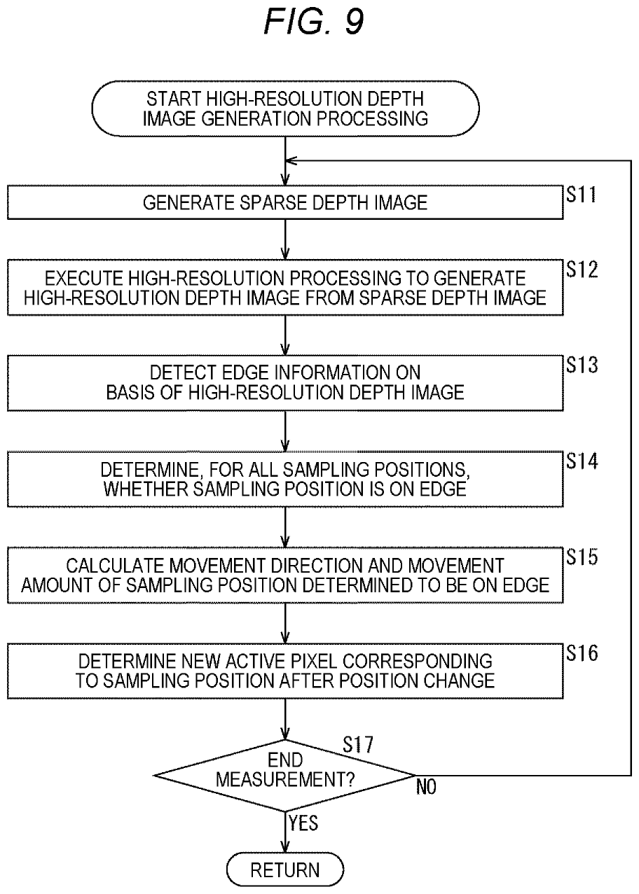

Details of the high-resolution depth image generation processing executed as step S4 in FIG. 8 will be described with reference to a flowchart in FIG. 9.

First, in step S11, the signal processing unit 53 of the distance measuring device 12 generates a sparse depth image. Specifically, the peak of the histogram is detected in units of a macropixel by a series of processing of the time measurement unit 71ᵢ, the histogram generation unit 72ᵢ, and the peak detection unit 73ᵢ (i=any one of 1 to N), and a count value corresponding to the peak is supplied to the distance calculation unit 74. The distance calculation unit 74 calculates the distance to the subject on the basis of the count value of the histogram peak supplied in units of a macropixel. Then, a sparse depth image in which the calculated distance to the subject is stored as a pixel value is generated.

In step S12, the distance calculation unit 74 executes high-resolution processing to generate a high-resolution depth image having the same resolution as a color image generated by the RGB camera from the sparse depth image. The generated high-resolution depth image is output to the outside via the input/output unit 54 and supplied to the edge information detection unit 75.

In step S13, the edge information detection unit 75 detects edge information indicating a boundary of an object on the basis of the high-resolution depth image supplied from the distance calculation unit 74, and supplies the detection result to the adaptive sampling unit 76.

In step S14, the adaptive sampling unit 76 determines, for all sampling positions, whether the sampling position is on an edge on the basis of the edge information of the object supplied from the edge information detection unit 75.

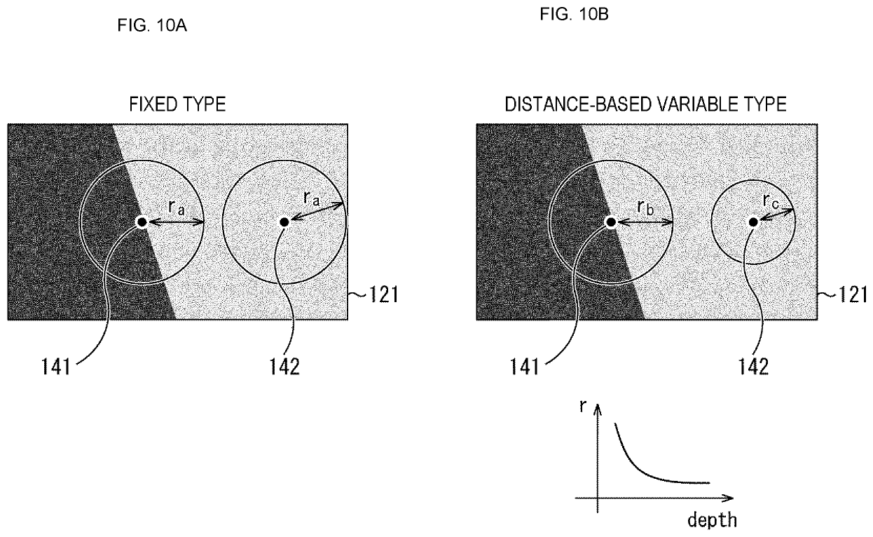

FIG. 10 is a diagram illustrating processing of determining whether a sampling position is on an edge, for the first sampling position 141 and the second sampling position 142 in the region 121 illustrated in FIG. 7.

The adaptive sampling unit 76 determines whether or not there is an edge of an object within a range of a predetermined threshold value r centered on a determination target sampling position, thereby determining whether or not the determination target sampling position is on an edge. The predetermined threshold value r is determined in advance.

A of FIG. 10 illustrates an example in a case where the predetermined threshold value r is set as a fixed value. In both the first sampling position 141 and the second sampling position 142, the threshold value r is set to the same value rₐ.

The fixed threshold value rₐ can be set to a value larger than a spot diameter in a case where the illumination device 11 irradiates the subject with irradiation light in spot irradiation, for example.

Alternatively, the fixed threshold value rₐ can be determined by, for example, a predetermined ratio (e.g., 50%) with respect to an interval from a nearby sampling position. The determination may be made by a predetermined ratio with respect to an average value of intervals between all sampling positions in an irradiation area, instead of a predetermined ratio with respect to an interval from a nearby sampling position.

Alternatively, the fixed threshold value rₐ can be set to a value larger than an alignment error between the RGB camera and the distance measuring device 12.

On the other hand, B of FIG. 10 illustrates an example of a distance-based variable type in which the predetermined threshold value r is variable in accordance with the distance (depth value). For example, the threshold value r is set on the basis of a decision function of the depth value and the threshold value r illustrated in B of FIG. 10. According to the decision function in FIG. 10, the threshold value r is set such that the threshold value r is inversely proportional to the depth value, that is, the threshold value r increases as the distance to the object is shorter. In the first sampling position 141 and the second sampling position 142 in the region 121, the depth value of the first sampling position 141 is smaller (the distance is shorter) than the depth value of the second sampling position 142, and thus a threshold value r_{b} of the first sampling position 141 in B of FIG. 10 is set to be larger than a threshold value r_{c} of the second sampling position 142 (r_{b}>r_{c}).

In the example in FIG. 10, in both of a case where the predetermined threshold value r is set as a fixed type and a case where the predetermined threshold value r is set as a distance-based variable type, the first sampling position 141 is determined to be on an edge because there is an edge within the range of the predetermined threshold value r. The second sampling position 142 is determined to be not on any edge.

Returning to FIG. 9, in step S15, the adaptive sampling unit 76 calculates a movement direction and a movement amount of a sampling position determined to be on an edge.

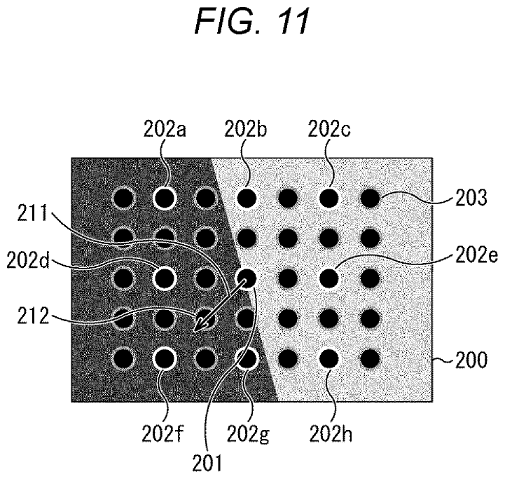

A method of determining a movement direction and a movement amount of a sampling position determined to be on an edge will be described with reference to FIGS. 11 to 13. In FIGS. 11 to 13, for the sake of simplicity, the description is based on an assumption that a sampling position is set in units of one pixel.

In a region 200 illustrated in FIG. 11, points 202a to 202h, which are white surrounding the peripheries of black dots, represent active pixels, and each of points 203, which are gray surrounding the peripheries of black dots, represents an inactive pixel.

A method of determining a movement direction and a movement amount of a sampling point 201, the sampling point 201 being set as an active pixel in the region 200 and positioned at the center now, in a case where it has been determined that the sampling point 201 is on an edge will be described.

First, the adaptive sampling unit 76 determines a barycentric position by using depth values of a plurality of sampling points 202 in regions near the sampling point 201 to be moved. For example, the barycentric position is determined by using positions (x, y) and depth values d of the eight sampling points 202a to 202h adjacent to the periphery of the sampling point 201 as the regions near the sampling point 201 to be moved. The depth values d of the eight sampling positions 202a to 202h are acquired from a high-resolution depth image.

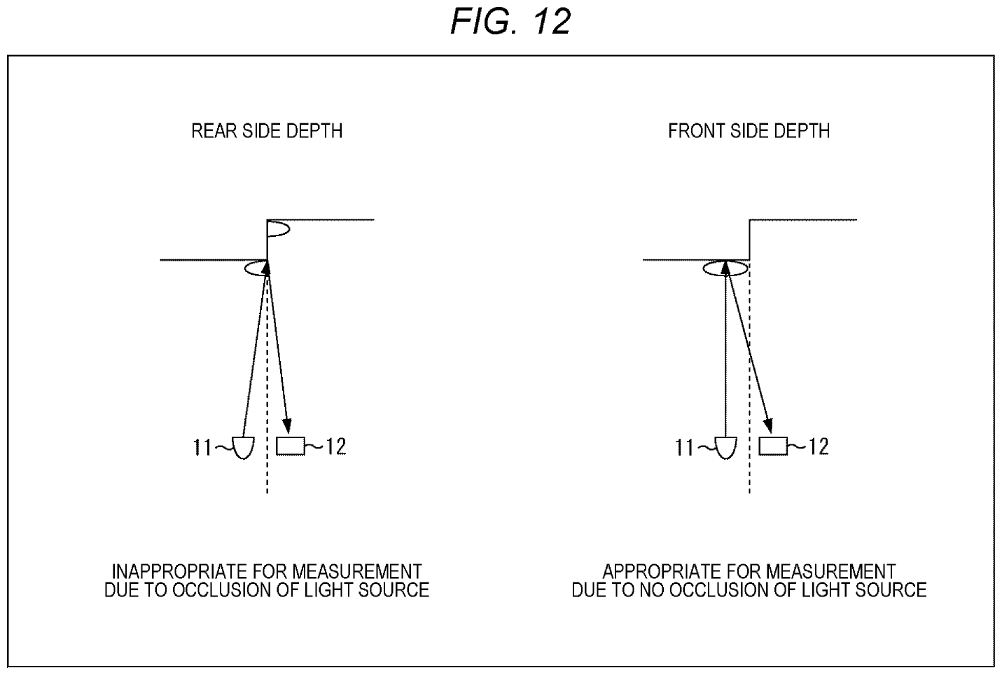

Here, as a weight in a case of determining the barycentric position by using the depth values of the nearby regions, a weight inversely proportional to the depth value is adopted such that the weight is larger as the distance is shorter. As illustrated in FIG. 12, in a case where irradiation light hits a boundary of an object, there is no occlusion of the light source in a subject on the front side, which is suitable for measurement, but occlusion of the light source occurs in a subject on the rear side, which prevents accurate measurement. Furthermore, this is because it is generally considered that depth information on the front side is more important than depth information on the rear side as depth information of a subject.

In the example in FIG. 11, the weights of the sampling points 202a, 202d, 202f, and 202g on the front side are set to weights larger than the weights of the sampling points 202b, 202c, 202e, and 202h on the rear side. The adaptive sampling unit 76 calculates the barycentric position by using the positions (x, y) and depth values d of the plurality of sampling points 202 in the regions near the sampling point 201 to be moved. The adaptive sampling unit 76 determines a direction from the current position of the sampling point 201 toward the barycentric position obtained by the calculation as the movement direction of the sampling position.

Next, the adaptive sampling unit 76 determines the movement amount of the sampling point 201. For example, the adaptive sampling unit 76 determines the movement amount in accordance with the spot diameter in a case where the illumination device 11 performs irradiation of irradiation light in spot irradiation. More specifically, a predetermined value larger than the spot diameter can be determined as the movement amount. With this arrangement, a position where the spot diameter does not overlap with any edge can be set as a new sampling position.

Alternatively, the movement amount may be determined on the basis of an alignment error between the RGB camera and the distance measuring device 12. Specifically, a predetermined value larger than the alignment error can be determined as the movement amount. With this arrangement, even in a case where there is an alignment error between the RGB camera and the distance measuring device 12, a position that does not overlap with any edge can be set as a new sampling position. It is also possible to determine a predetermined value larger than the alignment error as the movement amount in a case where the irradiation method is planar irradiation, and determine a predetermined value larger than each of the spot diameter and the alignment error as the movement amount in a case where the irradiation method is spot irradiation.

A movement vector 211 in FIG. 11 indicates the movement direction and movement amount computed for the sampling point 201 to be moved.

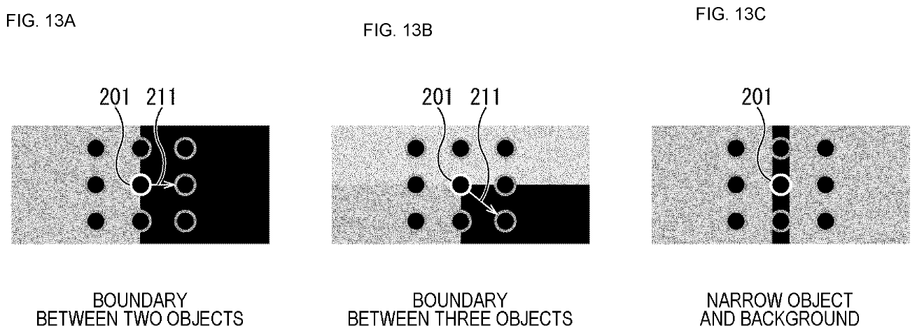

A of FIG. 13 illustrates an example of the movement vector 211 of the sampling point 201 in a case where the sampling point 201 to be moved is on an edge between two objects.

B of FIG. 13 illustrates an example of the movement vector 211 of the sampling point 201 in a case where the sampling point 201 to be moved is on edges between three objects.

C of FIG. 13 illustrates an example in which the movement vector 211 of the sampling point 201 cannot be determined because the sampling point 201 to be moved is on a narrow object and the barycentric position overlaps with the current sampling point 201. As described above, there may be a case where the movement vector 211 of the sampling point 201 cannot be determined. In a case where the movement vector 211 of the sampling point 201 cannot be determined as in C of FIG. 13, it is possible to provide the sampling point with a flag or the like indicating that the sampling point is a sampling point with low reliability, and reduce the weight at the time of using the depth value in generating a high-resolution depth image. Alternatively, the sampling point for which the movement vector 211 cannot be determined may only be changed from an active pixel to an inactive pixel.

In step S15 in FIG. 9, the movement direction and the movement amount of the sampling position determined to be on an edge are calculated as described above. As for the sampling position determined to be on an edge of an object, the adaptive sampling unit 76 changes the position information to position information of a new sampling position obtained by moving the sampling position in accordance with the calculated movement direction and movement amount. Then, the adaptive sampling unit 76 supplies sampling position information of all sampling positions to the position determination unit 61 of the control unit 51.

In step S16, the position determination unit 61 acquires, from the adaptive sampling unit 76, the sampling position information of all sampling positions. Then, the position determination unit 61 determines a new active pixel corresponding to the sampling position after the position change (new sampling position), and determines, as an inactive pixel, an active pixel that is no longer required to perform a light receiving operation in accordance with the change in the sampling position. The position determination unit 61 refers to a sampling pattern table in the internal memory, and determines, as a new active pixel, a pixel of the light receiving unit 52 closest to the new sampling position. In a case where there is no pixel of the light receiving unit 52 closest to the new sampling position, for example, in a case where the new sampling position is outside the pixel array, a new active pixel may not be set.

In step S17, the control unit 51 determines whether or not to end the distance measurement. For example, in a case where a high-resolution depth image has been generated and output a predetermined number of times determined in advance, the control unit 51 determines that the distance measurement is to be ended. Furthermore, for example, in a case where the position information of the new sampling position is not included in the sampling position information of all sampling positions supplied from the adaptive sampling unit 76, that is, in a case where a high-resolution depth image has been generated in a state where all active pixels are not on any boundary of any object, the control unit 51 may determine that the distance measurement is to be ended.

In a case where it has been determined in step S17 that the distance measurement is not yet to be ended, the processing returns to step S11, and the above-described steps S11 to S17 are repeated.

On the other hand, in a case where it has been determined in step S17 that the distance measurement is to be ended, high-resolution depth generation processing in FIG. 9 is ended, and the distance measuring processing in FIG. 8 is also ended.

According to the distance measuring processing described above, it is determined whether or not sampling positions at the time of generating a sparse depth image are on an edge of an object, and a sampling position determined to be on an edge is controlled to move to a place with no edge. By sampling while avoiding a boundary of an object, a sparse depth image can be generated with higher accuracy. For example, in a case where there is an object between sampling positions and a boundary of the object overlaps with the sampling positions, the object may be hidden when the resolution is increased. By performing sampling while avoiding the boundary of the object, it is possible to reduce hiding of the object when the resolution is increased.

As for the movement direction of a sampling position determined to be on an edge, the sampling position is moved toward a region of an object on the front side, the object being one of two objects having different depth directions. With this arrangement, it is possible to reduce an influence of occlusion of the light source and generate a sparse depth image with higher accuracy. Since a sparse depth image can be generated with higher accuracy, a high-resolution depth image can also be generated with higher accuracy.

Furthermore, the movement amount of the sampling position determined to be on an edge can be set to a predetermined value larger than the spot diameter in a case of irradiation of irradiation light in spot irradiation. With this arrangement, a position where the spot diameter does not overlap with any edge can be set as a new sampling position, and a sparse depth image can be generated with higher accuracy. Since a sparse depth image can be generated with higher accuracy, a high-resolution depth image can also be generated with higher accuracy.

Furthermore, as the movement amount of the sampling position, a predetermined value larger than an alignment error between the RGB camera that generates a color image and the distance measuring device 12 can be determined as the movement amount. The high-resolution depth image is generated so as to correspond to a color image actually viewed by a user. In a case where there is an alignment error between the RGB camera that generates a color image and the distance measuring device 12, the depth is associated with an incorrect position due to the alignment error. By setting a position that does not overlap with any edge as a new sampling position in consideration of an alignment error, it is possible to measure the depth at a position correctly corresponding to an object even in a case where there is an alignment error, and thus, it is possible to finally generate a high-resolution depth image with higher accuracy.

### 4. Another Example of High-Resolution Depth Generation Processing

In the distance measuring processing described above, the distance measuring device 12 detects edge information of an object by using a high-resolution depth image generated in the distance measuring mode and controls sampling positions with high accuracy, thereby increasing the accuracy of a high-resolution depth image.

The distance measuring device 12 may detect the edge information of the object by using not only the high-resolution depth image generated in the distance measuring mode but also a luminance image obtained in the luminance observation mode.

The following description shows processing of detecting edge information of an object by using both a high-resolution depth image generated in the distance measuring mode and a luminance image obtained in the luminance observation mode and controlling sampling positions with high accuracy, thereby generating a high-resolution depth image with high accuracy.

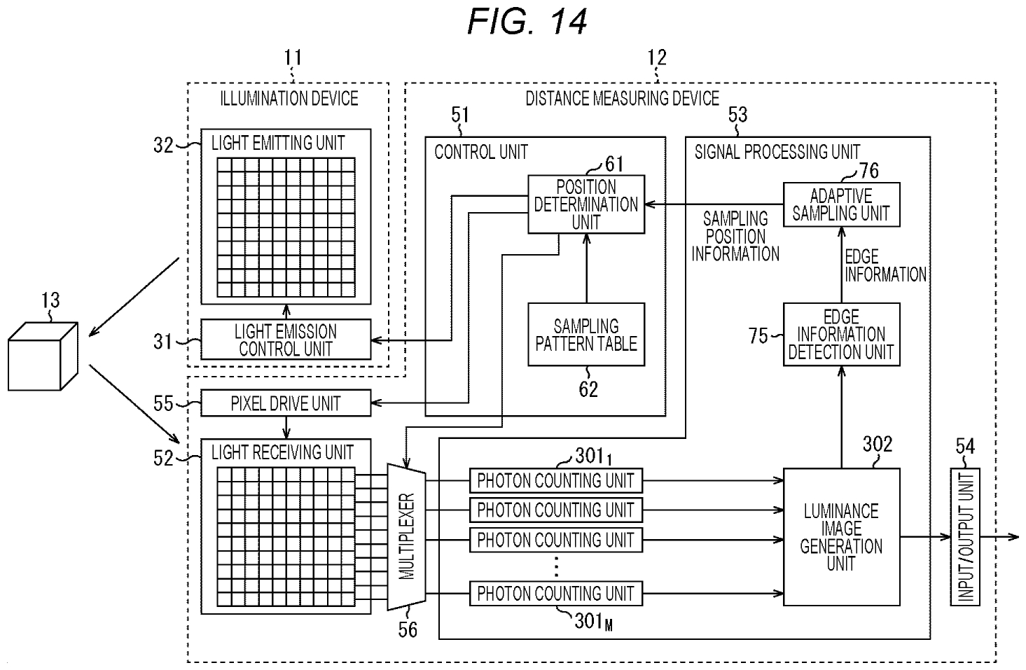

FIG. 14 is a block diagram illustrating a detailed configuration example of the distance measuring device 12 in a case where the distance measuring mode is the luminance observation mode.

In FIG. 14, portions that are in common with the configuration of the distance measuring device 12 in a case where the operation mode is the distance measuring mode illustrated in FIG. 4 are denoted by the same reference numerals, and the description of the portions will be appropriately omitted.

In the distance measuring device 12 in which the operation mode is the observation luminance mode, the signal processing unit 53 is provided with photon counting units 301₁ to 301_{M} and a luminance image generation unit 302. Instead, the time measurement units 71₁ to 71_{N}, the histogram generation units 72₁ to 72_{N}, the peak detection units 73₁ to 73_{N}, and the distance calculation unit 74 are omitted. Other configurations of the distance measuring device 12 are similar to those in FIG. 4.

In a case where the operation mode is the observation luminance mode, all the pixels of the light receiving unit 52 are set as active pixels, and the M photon counting units 301₁ to 301_{M}, M corresponding to the number of pixels of the light receiving unit 52, operate. That is, the photon counting units 301 are provided one for each pixel of the light receiving unit 52. The multiplexer 56 connects the pixels of the light receiving unit 52 and the photon counting units 301 on a one-to-one basis, and supplies a pixel signal of each pixel of the light receiving unit 52 to the corresponding photon counting unit 301.

The photon counting unit 301ⱼ (j=any one of 1 to M) counts the number of times the SPAD of the corresponding pixel of the light receiving unit 52 has reacted within a predetermined period, that is, the number of times a photon has been incident. Then, the photon counting unit 301ⱼ supplies the counting result to the luminance image generation unit 302. The luminance image generation unit 302 generates a luminance image in which the result of counting photons measured in each pixel is used as a pixel value (luminance value), and supplies the luminance image to the edge information detection unit 75. The generated luminance image may also be output to the upper host device via the input/output unit 54.

Note that the result of counting photons may be not in units of a pixel but in units of a plurality of pixels. In this case, the number M of the photon counting units 301₁ to 301_{M} is smaller than the number of pixels of all the pixels of the light receiving unit 52.

The edge information detection unit 75 detects edge information indicating a boundary of an object on the basis of the luminance image supplied from the luminance image generation unit 302. A known technology can be used as a technology for detecting the edge information from the luminance image. Examples of the technology includes “Hardware implementation of a novel edge-map generation technique for pupil detection in NIR images”, Vineet Kumar, Abhijit Asati, Anu Gupta, (https://www.sciencedirect.com/science/article/pii/S221509861630 5456).

Furthermore, the edge information detection unit 75 detects edge information indicating a boundary of an object also on the basis of a high-resolution depth image generated in the distance measuring mode. Then, the edge information detection unit 75 detects final edge information of the object obtained by integrating the edge information detected from the luminance image and the edge information detected from the high-resolution depth image, and supplies the detection result to the adaptive sampling unit 76.

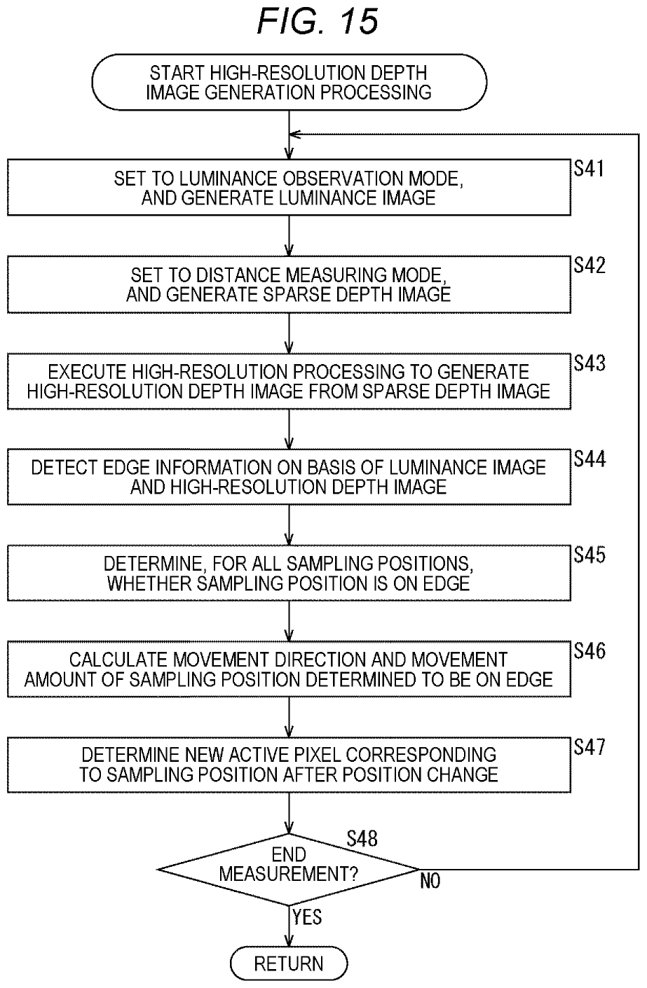

High-resolution depth image processing will be described with reference to a flowchart in FIG. 15, in which a high-resolution depth image is generated by using not only a high-resolution depth image generated in the distance measuring mode but also a luminance image obtained in the luminance observation mode.

The high-resolution depth image processing in FIG. 15 can be executed as step S4 in FIG. 8 instead of the high-resolution depth image processing in FIG. 9 described above.

Note that in a case of the luminance observation mode, it is possible to stop light emission of irradiation light by the illumination device 11 and generate a luminance image with only ambient light, or irradiation with uniform light such as planar irradiation as irradiation light may be performed. In each piece of processing of steps S1 to S3 in FIG. 8, it is possible to cause irradiation light to be emitted under individual light emission conditions for each of the distance measuring mode and the luminance observation mode. In the present embodiment, irradiation light is emitted under the same condition of planar irradiation in both of the two modes, and the description of steps S1 to S3 in FIG. 8 is omitted.

In the high-resolution depth image processing in FIG. 15, first, in step S41, the distance measuring device 12 sets the operation mode to the luminance observation mode, and generates a luminance image. More specifically, the number of times of incidence of photons within a predetermined period in each pixel of the light receiving unit 52 is counted by the photon counting unit 301ⱼ (j=1 to M), and the counting result is supplied from the photon counting unit 301ⱼ to the luminance image generation unit 302. The luminance image generation unit 302 generates a luminance image in which the result of counting photons measured in each pixel is used as a pixel value, and supplies the luminance image to the edge information detection unit 75. In step S42, the distance measuring device 12 sets the operation mode to the distance measuring mode, and generates a sparse depth image. This processing is similar to the processing in step S11 in FIG. 9.

In step S43, the distance calculation unit 74 executes high-resolution processing to generate a high-resolution depth image from the sparse depth image. The generated high-resolution depth image is output to the outside via the input/output unit 54 and supplied to the edge information detection unit 75.

In step S44, the edge information detection unit 75 detects edge information indicating a boundary of an object on the basis of the luminance image obtained in the luminance observation mode and the high-resolution depth image obtained in the distance measuring mode, and supplies the detection result to the adaptive sampling unit 76.

The processing in steps S45 to S48 is similar to the processing in steps S14 to S17 in FIG. 9, and the description thereof will be omitted.

In a case where the high-resolution depth image processing in FIG. 15 is adopted, it is possible to detect an edge of an object on the basis of both edge information based on a high-resolution depth image and edge information based on a luminance image, and determine whether or not a sampling position is on the edge of the object. Also using the edge information based on the luminance image of a domain different from the depth image allows for detecting an edge of an object that cannot be found out on the basis of only depth information, and allows for generating a high-resolution depth image with higher accuracy.

### 5. Modified Examples

In the above-described embodiment, it is determined whether or not a sampling position is on an edge of an object by additionally using edge information detected from a luminance image. Alternatively, it is possible to use a color image captured by the RGB camera used together with the distance measuring system 1. That is, it is possible to detect edge information of an object by using a color image, determine whether or not a sampling position is on the edge of the object by using both edge information of a high-resolution depth image and the edge information of the color image, and then move the sampling position. For detection of an edge of an object by using a color image, it is possible to use a technology for classifying a boundary (region) of an object by using a color image disclosed in “PointRend: Image Segmentation as Rendering” Alexander Kirillov Yuxin Wu Kaiming He Ross Girshick, (https://arxiv.org/pdf/1807.00275v2.pdf), for example. A high-resolution depth image is an image estimated from a sparse depth image, and there is no guarantee that the depth values of all the pixels are correct. A color image obtained by an RGB camera is an image obtained by actually imaging a subject, and thus the reliability of the edge information is high, and the accuracy of detecting an edge of an object can be further increased. With this arrangement, a high-resolution depth image can be generated with higher accuracy.

It is also possible to adopt a configuration in which the accuracy of detecting an edge of an object is further increased by using an image captured by another external camera other than the above-described RGB camera. Examples of the other external camera include an IR camera that captures infrared rays (far infrared rays or near infrared rays), a distance measuring sensor (distance measuring device) using an indirect ToF method, and an event-based vision sensor (EVS). The distance measuring sensor using the indirect ToF method is a distance measuring sensor that measures a distance to an object by detecting, as a phase difference, a flight time from a timing at which irradiation light is emitted to a timing at which the reflected light is received. Furthermore, the EVS is a sensor having a pixel that photoelectrically converts an optical signal and outputs a pixel signal, the sensor outputting a temporal luminance change of the optical signal as an event signal (event data) on the basis of the pixel signal. Unlike a general image sensor that captures an image in synchronization with a vertical synchronizing signal and then outputs frame data of one frame (screen) in a period of the vertical synchronizing signal, the EVS outputs event data only at a timing when an event occurs, and is thus an asynchronous (or address control) camera.

It is possible to increase the accuracy of detecting edge information by detecting and using edge information on the basis of an image captured by an external camera such as an RGB camera or an IR camera, instead of using edge information of a luminance image in the luminance mode. Furthermore, since it is not necessary to perform driving (generation of a luminance image) in the luminance mode in the distance measuring device 12, a frame rate of generating a high-resolution depth image can be doubled, and it is therefore possible to reduce an influence of a shift in position of a moving object due to a time difference or the like. With this arrangement, a high-resolution depth image can be generated with high accuracy.

Note that, as a matter of course, it is possible to detect an edge of an object by using edge information based on a high-resolution depth image, edge information based on a luminance image in the luminance mode, and edge information on the basis of sensor data from an external sensor, and then determine whether or not a sampling position is on the edge of the object. Also in this case, a high-resolution depth image can be generated with high accuracy.

### Application Examples

The above-described distance measuring system 1 can be mounted on, for example, an electronic device such as a smartphone, a tablet terminal, a mobile phone, a personal computer, a game device, a television receiver, a wearable terminal, a digital still camera, and a digital video camera.

The technology of the present disclosure can be adopted for imaging space recognition for virtual reality (VR) or augmented reality (AR) content, and can also be applied to, for example, a distance measuring sensor that is mounted on an automobile and measures a distance between vehicles or the like, a monitoring camera that monitors a traveling vehicle or a road, and an in-vehicle sensor that captures an image of the inside of a vehicle or the like.

In the present specification, a system means a set of a plurality of components (devices, modules (parts), and the like), and it does not matter whether or not all components are in the same housing. Therefore, a plurality of devices housed in separate housings and connected via a network and one device in which a plurality of modules is housed in one housing are both systems.

Furthermore, embodiments of the present technology are not limited to the embodiment described above but can be modified in a wide variety of ways within a scope of the present technology.

In the above-described embodiment, a sampling position is set by a macropixel constituted by a plurality of pixels, but, as a matter of course, a sampling position may be set in units of one pixel.

Note that the effects described in the present specification are merely examples and are not restrictive, and effects other than those described in the present specification may be obtained.

Note that the present technology can be configured as described below.
(1)

A distance measuring device including:
a light receiving unit that has a plurality of pixels that receive reflected light obtained from irradiation light reflected by an object;
a high-resolution processing unit that generates a high-resolution depth image from a sparse depth image acquired by the light receiving unit; and
a position determination unit that determines an active pixel in which a light receiving operation is performed in the light receiving unit on the basis of edge information of the high-resolution depth image.
(2)

The distance measuring device according to (1), further including:
a sampling unit that determines whether or not a sampling position set as an active pixel is on an edge of an object on the basis of the edge information of the high-resolution depth image.
(3)

The distance measuring device according to (2), in which
the sampling unit determines whether or not the sampling position is on an edge of an object by determining whether or not there is an edge of an object within a predetermined range centered on the sampling position.
(4)

The distance measuring device according to (3), in which
the predetermined range is a value larger than an alignment error between an external camera and the distance measuring device.
(5)

The distance measuring device according to (3), in which
the predetermined range is a value larger than a spot diameter of the irradiation light.
(6)

The distance measuring device according to (3), in which
the predetermined range is a value determined by a predetermined ratio with respect to an interval from a nearby sampling position.
(7)

The distance measuring device according to (3), in which
the predetermined range is a value determined by a predetermined ratio with respect to intervals between all sampling positions in an irradiation area.
(8)

The distance measuring device according to (3), in which
the predetermined range is a value that is variable in accordance with a depth value of the sampling position.
(9)

The distance measuring device according to (3), in which
the predetermined range is a value that is variable in such a way as to be inversely proportional to a depth value of the sampling position.
(10)

The distance measuring device according to any one of (2) to (9), in which
in a case where it has been determined that the sampling position is on an edge of an object, the sampling unit determines a movement direction and a movement amount for moving the sampling position.
(11)

The distance measuring device according to (10), in which
the sampling unit determines a barycentric position by using other sampling positions near the sampling position, and determines a direction toward the barycentric position as the movement direction.
(12)

The distance measuring device according to (11), in which
the sampling unit sets weights of front side sampling positions among the other sampling positions to be larger than weights of rear side sampling positions among the other sampling positions to determine the barycentric position.
(13)

The distance measuring device according to any one of (10) to (12), in which

the sampling unit sets the movement amount on the basis of an alignment error between an external camera and the distance measuring device.
(14)

The distance measuring device according to any one of (10) to (12), in which
the sampling unit determines the movement amount in accordance with a spot diameter of the irradiation light.
(15)

The distance measuring device according to any one of (1) to (14), further including:
an edge information detection unit that detects the edge information indicating a boundary of an object on the basis of the high-resolution depth image.
(16)

The distance measuring device according to (15), in which
the edge information detection unit detects the edge information on the basis of the high-resolution depth image and an image captured by an external camera.
(17)

The distance measuring device according to any one of (1) to (16), in which
the position determination unit determines the active pixel also on the basis of a size and a position of the irradiation light.
(18)

A method for controlling a distance measuring device, the method including:
by the distance measuring device including a light receiving unit that has a plurality of pixels that receive reflected light obtained from irradiation light reflected by an object,
generating a high-resolution depth image from a sparse depth image acquired by the light receiving unit; and
determining an active pixel in which a light receiving operation is performed in the light receiving unit on the basis of edge information of the high-resolution depth image.
(19)

A distance measuring system including:
an illumination device that performs irradiation of irradiation light; and
a distance measuring device that receives reflected light obtained from the irradiation light reflected by an object,
in which the distance measuring device includes:
a light receiving unit that has a plurality of pixels that receive the reflected light;
a high-resolution processing unit that generates a high-resolution depth image from a sparse depth image acquired by the light receiving unit; and
a position determination unit that determines an active pixel in which a light receiving operation is performed in the light receiving unit on the basis of edge information of the high-resolution depth image.
(20)

The distance measuring system according to (19), in which
the distance measuring device determines light emission conditions of the irradiation light including an irradiation method, an irradiation area, and an irradiation pattern, and
the illumination device causes the irradiation light based on the light emission conditions to be emitted.

### REFERENCE SIGNS LIST

1 Distance measuring system
11 Illumination device
12 Distance measuring device
31 Light emission control unit
32 Light emitting unit
33 Diffractive optical element (DOE)
51 Control unit
52 Light receiving unit
53 Signal processing unit
61 Position determination unit
71₁ to 71_{N} Time measurement unit
72₁ to 72_{N} Histogram generation unit
73₁ to 73_{N} Peak detection unit
74 Distance calculation unit
75 Edge information detection unit
76 Adaptive sampling unit
301₁ to 301_{M} Photon counting unit
302 Luminance image generation unit

1. A distance measuring device comprising:
a light receiving unit that has a plurality of pixels that receive reflected light obtained from irradiation light reflected by an object;
a high-resolution processing unit that generates a high-resolution depth image from a sparse depth image acquired by the light receiving unit; and
a position determination unit that determines an active pixel in which a light receiving operation is performed in the light receiving unit on a basis of edge information of the high-resolution depth image.

2. The distance measuring device according to claim 1, further comprising:
a sampling unit that determines whether or not a sampling position set as an active pixel is on an edge of an object on a basis of the edge information of the high-resolution depth image.

3. The distance measuring device according to claim 2, wherein
the sampling unit determines whether or not the sampling position is on an edge of an object by determining whether or not there is an edge of an object within a predetermined range centered on the sampling position.

4. The distance measuring device according to claim 3, wherein
the predetermined range is a value larger than an alignment error between an external camera and the distance measuring device.

5. The distance measuring device according to claim 3, wherein
the predetermined range is a value larger than a spot diameter of the irradiation light.

6. The distance measuring device according to claim 3, wherein
the predetermined range is a value determined by a predetermined ratio with respect to an interval from a nearby sampling position.

7. The distance measuring device according to claim 3, wherein
the predetermined range is a value determined by a predetermined ratio with respect to intervals between all sampling positions in an irradiation area.

8. The distance measuring device according to claim 3, wherein
the predetermined range is a value that is variable in accordance with a depth value of the sampling position.

9. The distance measuring device according to claim 3, wherein
the predetermined range is a value that is variable in such a way as to be inversely proportional to a depth value of the sampling position.

10. The distance measuring device according to claim 2, wherein
in a case where it has been determined that the sampling position is on an edge of an object, the sampling unit determines a movement direction and a movement amount for moving the sampling position.

11. The distance measuring device according to claim 10, wherein
the sampling unit determines a barycentric position by using other sampling positions near the sampling position, and determines a direction toward the barycentric position as the movement direction.

12. The distance measuring device according to claim 11, wherein
the sampling unit sets weights of front side sampling positions among the other sampling positions to be larger than weights of rear side sampling positions among the other sampling positions to determine the barycentric position.

13. The distance measuring device according to claim 10, wherein
the sampling unit sets the movement amount on a basis of an alignment error between an external camera and the distance measuring device.

14. The distance measuring device according to claim 10, wherein
the sampling unit determines the movement amount in accordance with a spot diameter of the irradiation light.

15. The distance measuring device according to claim 1, further comprising:
an edge information detection unit that detects the edge information indicating a boundary of an object on a basis of the high-resolution depth image.

16. The distance measuring device according to claim 15, wherein
the edge information detection unit detects the edge information on a basis of the high-resolution depth image and an image captured by an external camera.

17. The distance measuring device according to claim 1, wherein
the position determination unit determines the active pixel also on a basis of a size and a position of the irradiation light.

18. A method for controlling a distance measuring device, the method comprising:
by the distance measuring device including a light receiving unit that has a plurality of pixels that receive reflected light obtained from irradiation light reflected by an object,
generating a high-resolution depth image from a sparse depth image acquired by the light receiving unit; and
determining an active pixel in which a light receiving operation is performed in the light receiving unit on a basis of edge information of the high-resolution depth image.

19. A distance measuring system comprising:
an illumination device that performs irradiation of irradiation light; and
a distance measuring device that receives reflected light obtained from the irradiation light reflected by an object,
wherein the distance measuring device includes:
a light receiving unit that has a plurality of pixels that receive the reflected light;
a high-resolution processing unit that generates a high-resolution depth image from a sparse depth image acquired by the light receiving unit; and
a position determination unit that determines an active pixel in which a light receiving operation is performed in the light receiving unit on a basis of edge information of the high-resolution depth image.

20. The distance measuring system according to claim 19, wherein
the distance measuring device determines light emission conditions of the irradiation light including an irradiation method, an irradiation area, and an irradiation pattern, and
the illumination device causes the irradiation light based on the light emission conditions to be emitted.
